(19) United States
(12) Patent Application Publication
(10) Pub. No.: US 2004/0220907 A1
(43) Pub. Date: Nov. 4, 2004

(54) Technique for searching for contact information concerning desired parties

(76) Inventor: David W. Camarillo, Portland, OR (US)

Correspondence Address: Alex L. Yip, Kaye Scholer LLP, 425 Park Avenue, New York, NY, 10022, US

(21) Appl. No.: 10/427,650

(22) Filed: Apr. 30, 2003

(51) Int. Cl. G06F 7/00

(52) U.S. Cl. 707/3

(57) ABSTRACT

The invention is directed to selecting the latest contact information for a searched party, e.g., an individual, based on the searched party's known, old contact information contained in an old record. A number of searches are conducted based on variations of criteria derived from the old record information. After receiving the search results corresponding to all criteria variations, they are analyzed in accordance with the invention. Each criteria variation may be preassigned a confidence measure reflecting how likely the search results contain the derived, latest contact in formation. The actual value of one such confidence measure may be determined based on past experience or there statistical measures. The analysis is based, among other things, on the confidence measure and on the number of search results returned for a particular criteria variations. Depending on the search requirements of a requesting party, one or more search results containing the latest contact information for the searched party and their associated confidence measures may be returned.

### FIELD OF THE INVENTION

The invention relates to systems and methods of searching for contact information concerning desired parties, e.g., individuals.

### BACKGROUND OF THE INVENTION

It is commonplace that a company supplying products or services to a large group of consumers has a need to contact some of those consumers from time to time. For example, the company may need to inform a consumer of a product recall, or discuss an extended product warranty or the status of a consumer's account, e.g., a delinquency in payments, etc. The contact with a consumer sometimes becomes difficult to maintain due to a consumer's changes of contact information, e.g., address of residence or employment, phone numbers thereof, email addresses, etc. The company may wish to locate the most current contact information for the consumers by searching through a variety of databases, e.g., credit reports, electronic white pages, driver's license databases, etc.

The prior art process of searching for an individual's latest contact information given his/her old contact information has proven inefficient and unreliable because many people have common names, e.g., John Smith, which renders in a large number of search results from which the most likely latest contact information for the individual is selected.

### SUMMARY OF THE INVENTION

The present invention overcomes the prior art limitations by conducting a number of searches based on variations of criteria derived from the old contact information contained in an old record. The old record may include, among others, name and outdated contact information about a searched party, e.g., first name, last name, street name, city, phone number, etc. These searches may be conducted in one or more databases, e.g., a nationwide white pages database, a statewide white pages database, etc.

The criteria variations may be developed by removing or translating an element of the old record. For example, when the first name element is removed from a criteria set, the search results would include matches for other criteria, e.g., last name, city, etc., and any first name in the database. Translation is a process that varies an element of the old record but in a non-substantive way. For example, a translation of the first name element may mean that in addition to the first name in the old record, e.g., “William,” the first name searched may include its equivalents or common variations, i.e., “Bill,” “Will,” “W,” etc.

After receiving the search results corresponding to all criteria variations, the results are analyzed in accordance with the invention. Each criteria variation is assigned a confidence measure reflecting the likelihood that the search results corresponding to a particular criteria variation contains the desired latest contact information. The actual value of one such confidence measure may be pre-assigned based on past experience or other statistical measures. For example, a search combination, i.e., a criteria set, that contains only last name and first name elements may be assigned a confidence measure of 50, when a search combination that contains last name and first name elements and a geographic element, e.g., a state, a city, a zip code, an area code, may be assigned a confidence measure of 98 indicating a higher likelihood that a collection of search results produced by a search combination assigned a confidence measure of 98 may contain the desired latest contact information because this search combination includes a geographic limitation.

The confidence measure may also be dynamically ascertained based on the actual search data used. For example, in accordance with an aspect of the invention, a preassigned confidence measure may be adjusted as a result of a statistical analysis of the search data before a search is conducted, or depending on the actual results of the search using the search data.

The analysis is based, among other things, on the confidence measure and on the number of search results returned for a particular criteria variation. Depending on the search requirements of a requesting party, one or more search results containing the latest contact information for the searched party and their associated confidence measures may be returned. In an illustrative embodiment, the fewest search results returned in a search using a criteria variation with the highest confidence measure are selected. In another embodiment, the relatively few search results returned in a search using a criteria variation with a relatively low confidence measure are selected over of the relatively many search results returned in another search using a criteria variation with a relatively high confidence measure.

### BRIEF DESCRIPTION OF THE DRAWING

Further objects, features and advantages of the invention will become apparent from the following detailed description taken in conjunction with the accompanying drawings showing illustrative embodiments of the invention, in which:

FIG. 1 illustrates a searching system in accordance with the invention;

FIG. 2A illustrates an old record in accordance with the invention;

FIG. 2B illustrates a criteria set in accordance with the invention;

FIG. 3A illustrates a criteria set in accordance with the invention;

FIG. 3B illustrates a collection of search results in accordance with the invention;

FIG. 4A illustrates a criteria set in accordance with the invention;

FIG. 4B illustrates a collection of search results in accordance with the invention;

FIG. 5A illustrates a criteria set in accordance with the invention;

FIG. 5B illustrates a collection of search results in accordance with the invention;

FIG. 6A illustrates a criteria set in accordance with the invention;

FIG. 6B illustrates a collection of search results in accordance with the invention; and

FIGS. 7A, 7B and 7C are flow charts jointly depicting a routine for analysis of search results by database manager 28 in accordance with the invention.

### DETAILED DESCRIPTION

The invention is directed to searching for the latest contact information concerning a searched party, e.g., an individual, based on his/her previous contact information, i.e., an old record, and analyzing collections of search results in a systematic manner. In an illustrative embodiment, a number of searches are conducted based on variations of criteria derived from the old record information. After receiving collections of search results corresponding to different criteria variations, they are analyzed in accordance with the invention. Each criteria variation is assigned a confidence measure reflecting how likely the corresponding collection of search results contains the desired latest contact information. The value of one such confidence measure may be pre-assigned based on past experience or dynamically ascertained based on the actual search data used. The analysis is based, among other things, on the confidence measure and on the number of search results in a collection returned for a particular criteria variation. Depending on the search requirements of a requesting party, collections of one or more search results containing the latest contact information for the searched party and their associated confidence measures may be returned. In an illustrative embodiment, the fewest search results returned in a search using a criteria variation with the highest confidence measure are selected. In another embodiment, the relatively few search results returned in a search using a criteria variation with a relatively low confidence measure are selected over the relatively many search results returned in another search using a criteria variation with a relatively high confidence measure.

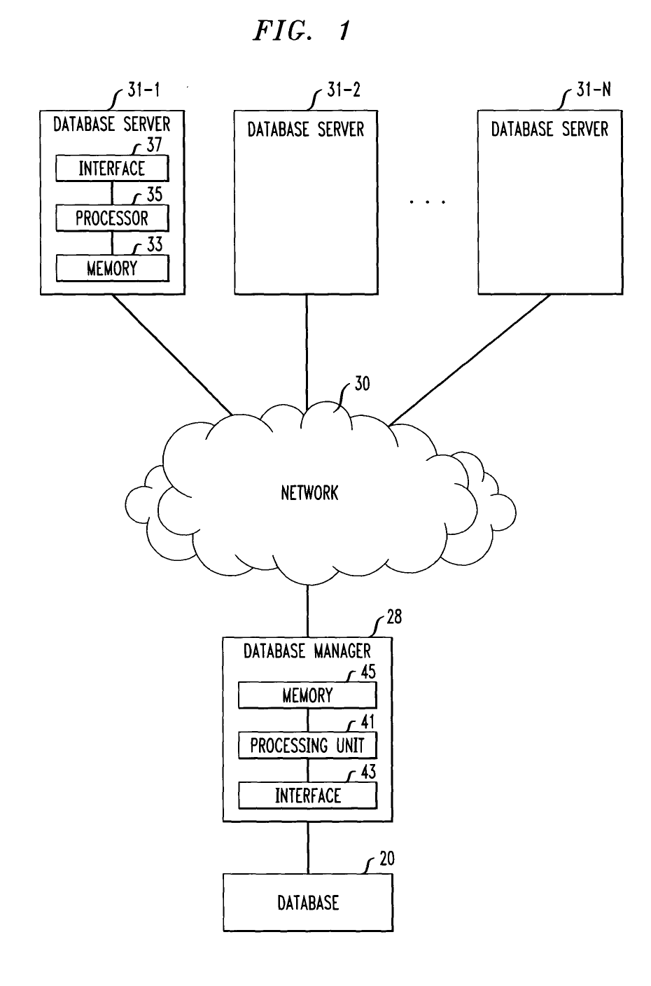

FIG. 1 illustrates a searching system embodying the principles of the invention for searching for the latest contact information concerning an individual based on that individual's old contact information. This searching system includes network 30 which may be, e.g., an Internet-based network such as the world wide web, or a private intranet based network. Network 30 connects one or more database servers 31-1, 31-2, . . . , 31-N, where N≧1, to database manager 28 which administers and maintains one or more databases 20 containing searchable contact information. A database server, say server 31-1, may comprise a personal computer, a terminal, input and output devices, etc., pre-installed with appropriate software in memory 33 for effecting a search through database manager 28. For example, a user at server 31-1 may input a search query using a user interface (not shown), e.g., a keyboard, connected thereto. Processor 35 may translate the search query to one in proper syntax understood by database manager 28. Processor 35 transmits the properly formatted search query to database manager 28 through interface 37. Database manager 28 then returns any search results responsive to the search query.

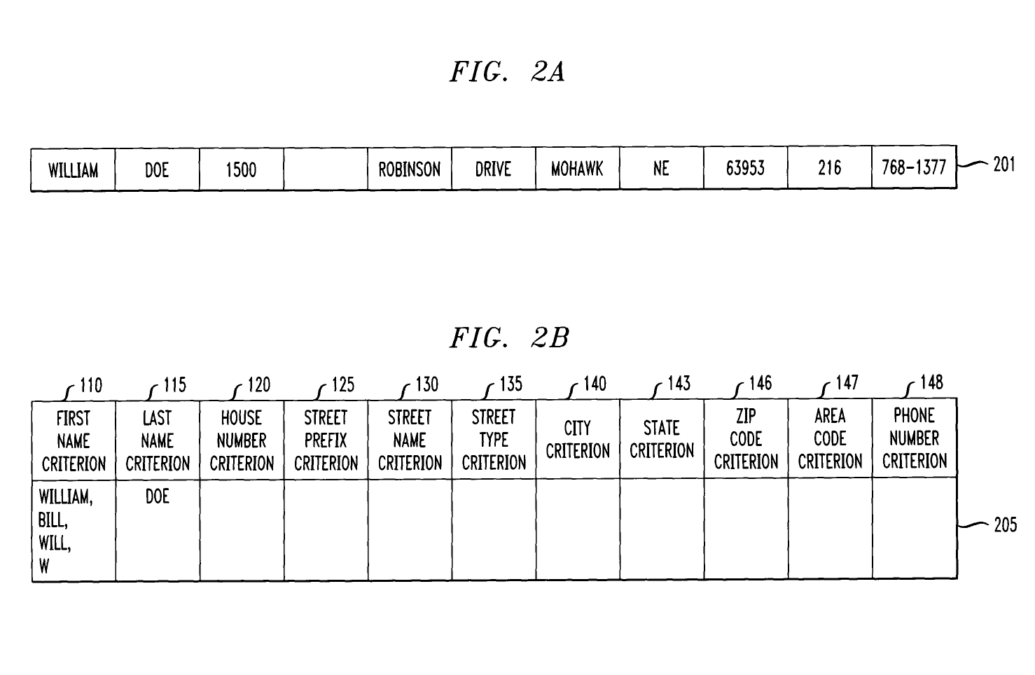

In this instance, say, ABC Clothing Store is trying to locate, among others, William Doe, one of its former customers, who purchased wardrobe on credit but did not make payments when due. ABC Clothing Store is trying to locate William Doe, who at the time he opened an account with the store, had been residing at 1500 Robinson Drive, Mohawk, Nebr. 64553; (216) 768-1377. The old contact information for William Doe in the ABC Clothing Store's database is outdated and referred to as an old record 201 illustrated in FIG. 2A. The store in this instance already tried to contact William Doe by mail and phone at 1500 Robinson Drive, Mohawk, Nebr. 64553; (216) 768-1377 to learn that he had moved without leaving a forwarding address and a different person now resides there.

In accordance with the invention, the latest contact information for William Doe is located using subsets of William Doe's previous contact information. For example, searching for just the last name, city, and state, derived from old record 201, may uncover “Does” listed at different addresses in the same city. Depending on how many such listings are returned, one or more of them may be a good lead for William Doe formerly residing at 1500 Robinson Drive, Mohawk, Nebr. 64553; (216) 768-1377.

In this illustrative embodiment of the invention, a user at server 31-1 enters the information in old record 201 as a search query, and may select a database to search, e.g., a nationwide white pages database, a Nebraska statewide white pages database, etc. In this example, all the searches are performed using the nationwide white pages database. The search query and the selection of the database, if any, are transmitted to database manager 28 through interface 43. In accordance with the invention, database manager 28 generates a number of criterion variations, based on the received search query to search the selected database. The criterion variations may be developed by removing or translating one or more elements of old record 201. For example, a criteria set can be constructed by removing first name from the full criteria set of old record 201, i.e, instead of searching for (William; Doe; . . . ), the new criteria set would be searching for ([Blank]; Doe; . . . ). Therefore, this search will return search results with the last name “Doe” and any first name, e.g., Mary, Ed, Algernon, etc. In another criteria variation, removal of an immaterial element, e.g., the street type, may help identify the latest contact information more efficiently. The street type, e.g., “Ave.,” “Blvd.,” or “Pkwy.,” is immaterial to the search in this example because if the street name in old record 201 matches the street name in one of the search results but their street types are different, it is likely that the street type either in old record 201 or in the selected database is a typographical error. Hence, it can be ignored without diminishing the likelihood of locating the latest contact information for William Doe.

Translation is a process that varies an element of old record 201 but in a non-substantive way. For example, a translation of the first name may mean that in addition to the first name in old record 201, i.e., “William,” the first name searched may include its equivalents or common variations for “William” retrieved from an electronic dictionary, i.e., “Bill,” “Will,” “W,” etc. The electronic dictionary is stored in memory 45 in this instance. In addition, a translation of “New York City” may be “Manhattan.” Moreover, translations can also take into account phonetic variations on data and/or typographical corrections and misspellings. Translations can also be used to eliminate unreasonably short letter or character sequences from old record 201, such as anything with one or two letters or characters. A last name may contain a “Jr” or “Sr”, but it may not be listed this way in the database. It has been observed that, as a general rule, removal of these sequences does not significantly affect the likelihood of finding the latest contact information.

Database manager 28 analyzes the search results based on the number of search results produced by a criteria set and the confidence measure assigned to the criteria set. Each criteria set may be pre-assigned a confidence measure based on prior experience with a particular variation, i.e., translation or removal, of a search criterion and the number of such variations in a particular criteria set. For example, a search combination, i.e., a criteria set, that contains only last name and first name elements may be assigned a confidence measure of 50, when a search combination that contains last name and first name elements and a geographic element, e.g., a state, a city, a zip code, an area code, may be assigned a confidence measure of 98, indicating a higher likelihood that a collection of search results produced by a search combination assigned a confidence measure of 98 may contain the desired latest contact information because this search combination includes a geographic limitation.

FIG. 2B illustrates criteria set 205 which includes search strings for First Name criterion 110 and Last Name criterion 115. Criteria set 105 includes a criterion translation for First Name criterion 110 “William” and its common variations, i.e., “Bill,” “Will,” “W.” All other search criteria, e.g., Street Prefix criterion 125, Zip Code criterion 146, Phone No. criterion 148, are not a factor here, and are thus left blank in criteria set 205. (The types of search strings that could be contained in First Name criterion 110, . . . Phone No. criterion 148 and their relationship to the contact information are self-explanatory from the title of each criterion.) In this instance, confidence measure of is pre-assigned to criteria set 205 because it is not limited by any geographic criteria, e.g., any city, state, zip code, etc., and thus may match any “William Doe” (and equivalents) living anywhere in the United States. In this illustrative embodiment, if criteria set 205 produces more search results than a first limit, say 60, this means that the (first name; last name) combination in criteria set 205 represents a common name, and no search result can be confidently declared to be the latest contact information. However, even if criteria set 205 produces fewer than 60 search results, depending on the number of search results returned using other criteria sets, database manager 28 may or may not declare that those search results would contain the desired contact information. Nevertheless, if criteria set 205 produces fewer than or equal to three search results, for example, this means that the (first name; last name) combination in criteria set 205 is a rare name, and manager 28 would declare that those search results would contain the desired contact information. In this instance, a let's say search of the nationwide white pages database using criteria set 205 produced 150 search results (not shown). All of them are associated with a confidence measure of because they were returned as a result of a search with criteria set 205 assigned a confidence measure of 50.

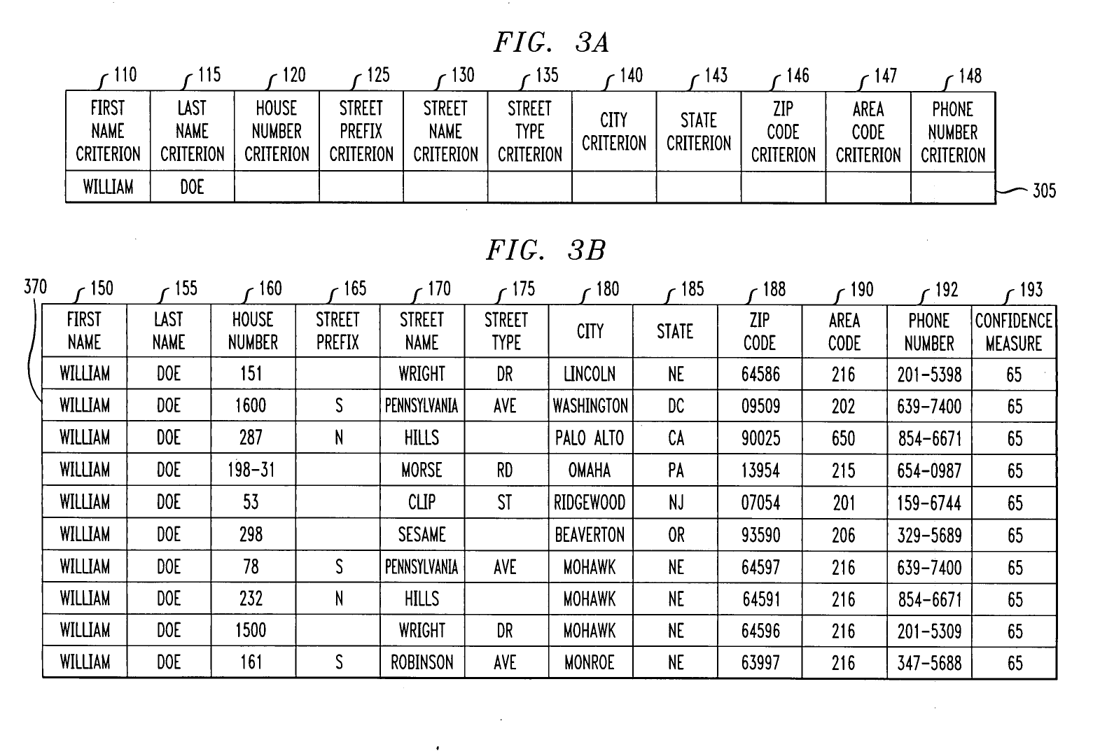

FIG. 3A illustrates criteria set 305 which includes search strings for First Name criterion 110 and Last Name criterion 115. Unlike criteria set 205, criteria set 305 does not allow translation of the first name in old record 201. Criteria set 305 in this instance is pre-assigned a confidence measure of 65 based on prior experience with the accuracy of search results of criteria set 305. The confidence measure for criteria set 305 here is higher than the confidence measure for an almost identical criteria set 205 because criteria set 305 does not allow translation of the first name. As a result, manager 28 is more confident to declare a name match and that the search results are desirable corresponding to set 305 than set 205. FIG. 3B illustrates a collection of search results produced using criteria set 305. It consists of ten records whose addresses are dispersed across the United States, with five records in Nebraska (NE). For example, record 370 contains “William” in First Name field 150, “Doe” in Last Name field 155, “1600” in House No. field 160, “S” in Street Prefix field 165, “Pennsylvania” in Street Name field 170, “Ave” in Street Type field 175, “Washington” in City field 180, “DC” in State field 185, “09509” in Zip Code field 188, “202” in Area Code field 190, “639-7400” in Phone No. field 192, “65” in Confidence Measure field 193.

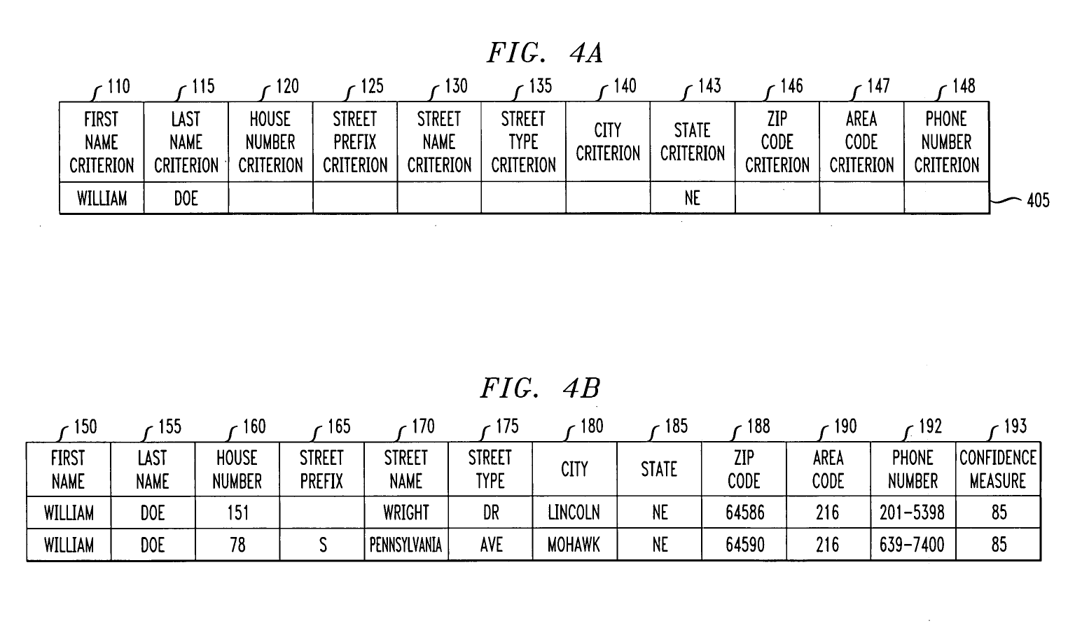

FIG. 4A illustrates criteria set 405 which includes search strings for First Name criterion 110, Last Name criterion 115, and State criterion 143 (“William,” “Doe,” and “NE”, respectively). Criteria set 405 is assigned a confidence measure of 85. The confidence measure for criteria set 405 here is higher than both confidence measures for criteria sets 205 and 305 because criteria set 405 includes a geographic limitation, i.e., state (on an assumption that a customer of ABC Clothing Store is more likely to move within the same state than out-of-state), and therefore the search using set 405 is expected to produce more likely the desired search result than criteria set 205 or 305. FIG. 4B illustrates a collection of search results corresponding to criteria set 405. It consists of five records in this instance.

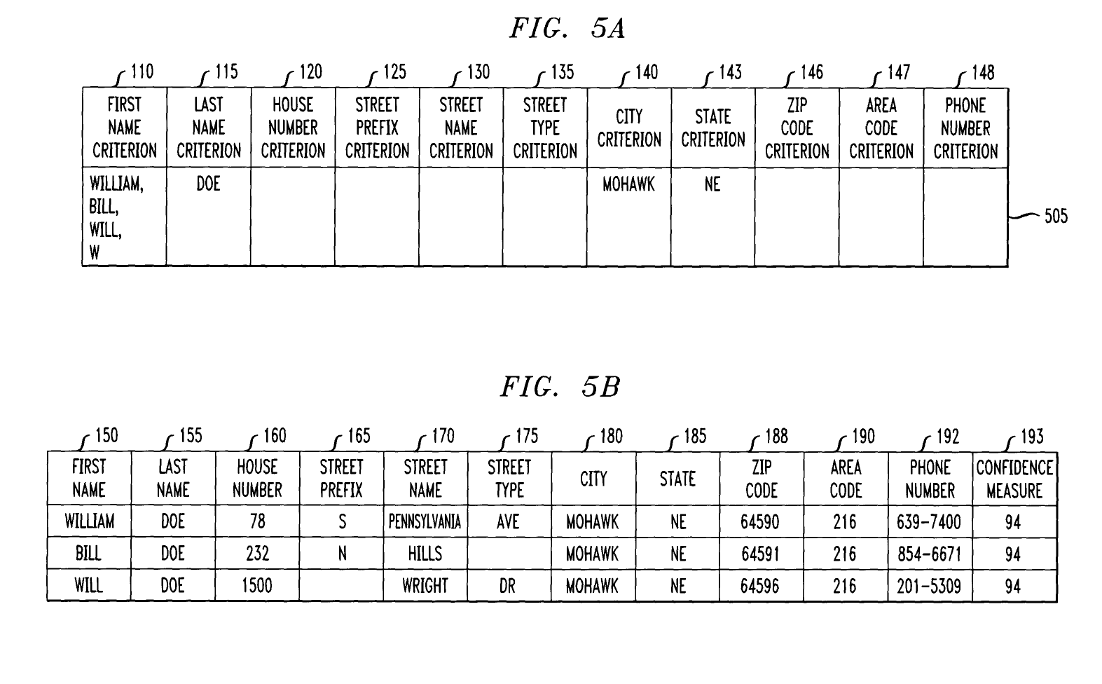

FIG. 5A illustrates criteria set 505 which includes search strings for First Name criterion 110, Last Name criterion 115, City criterion 140, and State criterion 143. Criteria set 505 includes a criterion translation for First Name criteria 110, i.e., “William” and its common variations “Bill,” “Will,” “W.” All other criteria included in criteria set 505 are exact strings from old record 201 (“Doe” in Last Name criterion 115, “Mohawk” in City criterion 140, “NE” in State criterion 143). Criteria set 505 in this instance is assigned a confidence measure of 94 because it includes a narrow geographic limitation (on an assumption that a customer of ABC Clothing Store is more likely to move within the same city and state) and a translation on a single search criterion (first name and corresponding name variations); hence, selection of a latest contact information can be made with a high degree of confidence from search results of criteria set 505. (A criteria set which does not allow for translation of the first name but is otherwise identical to criteria set 505 would be assigned a confidence measure of 95.) FIG. 5B illustrates a collection of search results produced by searching the nation-wide white pages database by criteria set 505. In this instance, it consists of three records.

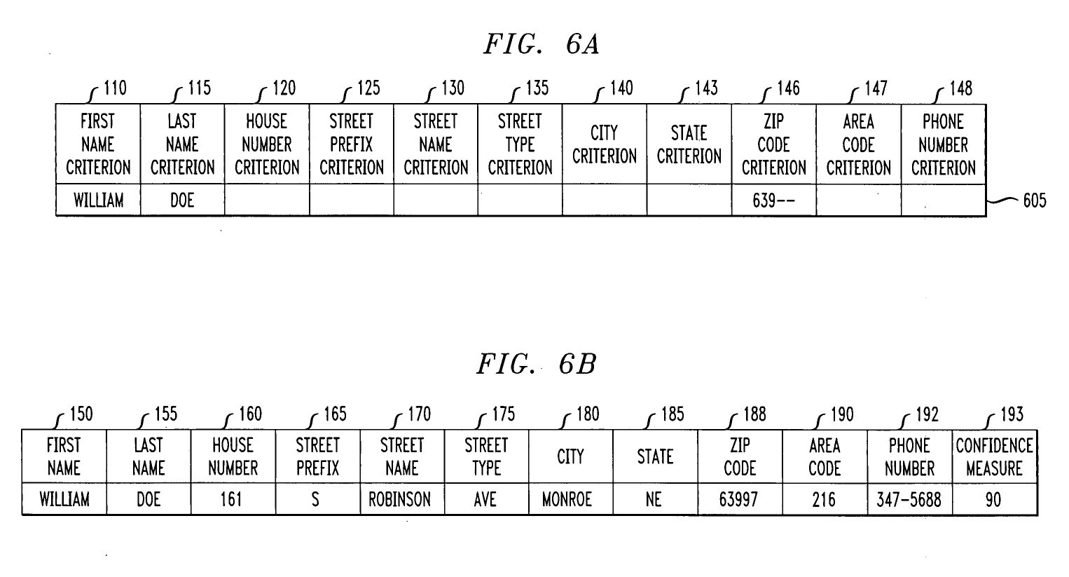

FIG. 6A illustrates criteria set 605 which includes search strings for First Name criterion 110, Last Name criterion 115, and a removal of Zip Code criterion 146 allowing the last two digits of a zip code to be any numerals (“William”, “Doe”, “645—”, respectively). Criteria set 605 has a confidence measure of 90. The confidence measure for criteria set 605 is lower than the confidence measure for criteria set 505 because the geographic limitation in criteria set 605 is more relaxed than in criteria set 505 because not only the zip code of old record 201 would match the Zip Code criterion 146 of criteria set 605, but also other zip codes belonging to other municipalities in the same state would match it. FIG. 6B illustrates a collection of search results produced by criteria set 605. It consists of one record in this instance. It should be noted that this search record, however, does not match any search records produced by criteria set 505.

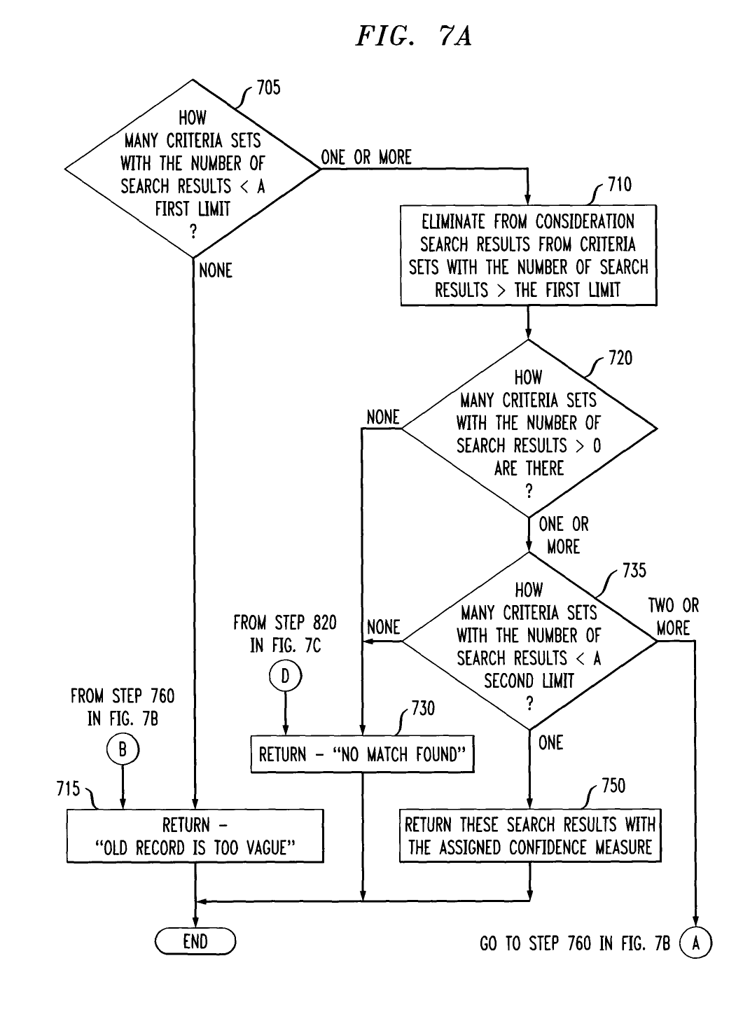

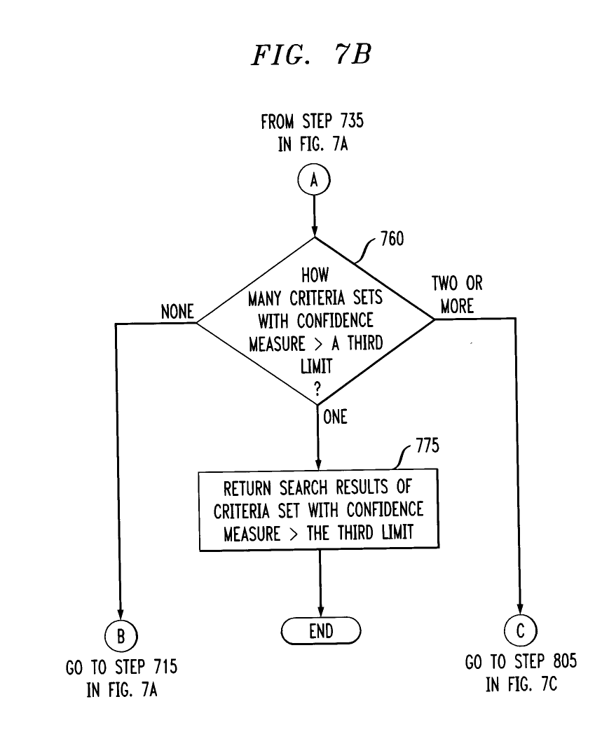

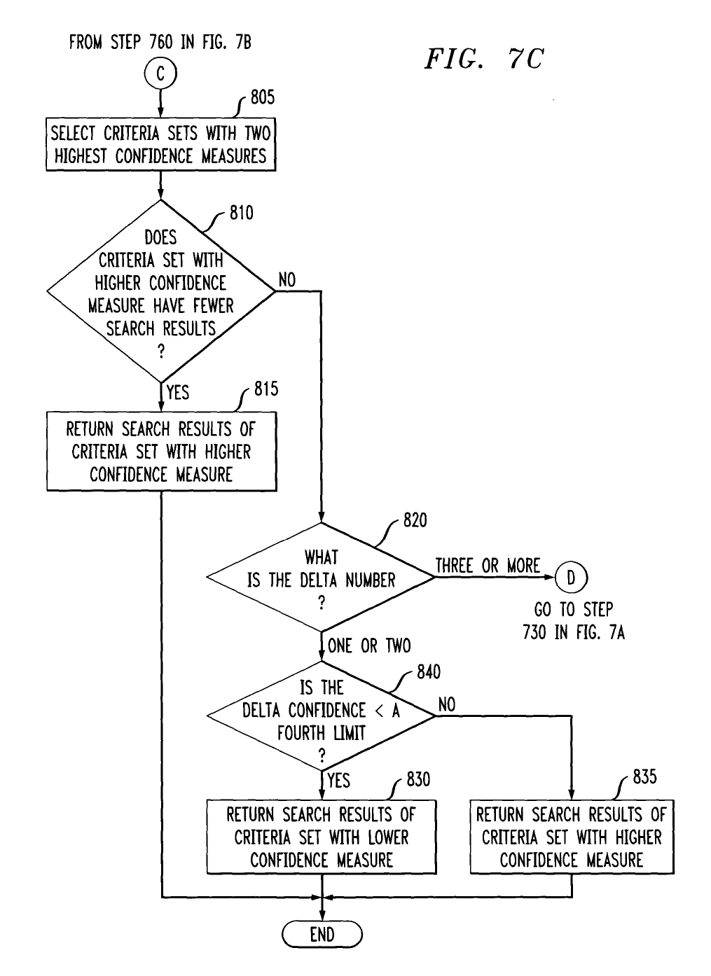

After obtaining collections of search results from searches with different criteria sets, i.e., the above-described collections illustrated in FIGS. 3B, 4B . . . , FIG. 6B, database manager 28 proceeds to analyze same. FIGS. 7A, 7B, and 7C jointly illustrate a routine performed by database manager 28 to analyze the collections of search results according to the present invention. In step 705, processing unit 41 in database manager 28 determines how many criteria sets with the number of search results in the respective collections smaller than a first limit are there. In this instance, this first limit is set at 60. The first limit represents a number of search results in a collection over which processing unit 41 determines that the search criteria in the corresponding criteria set are not limiting enough. If all criteria sets returned more than 60 search results, processing unit 41 proceeds to step 715, where it returns a message that the search criteria are too vague to confidently determine the desired latest contact information, and the routine ends. Otherwise, processing unit 41 proceeds to step 710, in which it eliminates from consideration criteria sets with the number of search results in the respective collections exceeding the first limit. Such excessive number of search results for any one criteria set could result from a searched party's name being a common one, which results in inability to further analyze the search results without additional data about the consumer (contained both in ABC Clothing Store's files and in the database searched). In the instant example, processing unit 41 would eliminate from consideration search results produced by criteria set 205 because criteria set 205 produces 150 search results, which exceeds the first limit of 60.

Now that one or more criteria sets with the number of search results smaller than 60 are left for further analysis, in step 720, processing unit 41 determines how many criteria sets have a number of search results greater than zero. If all criteria sets produce no search results, processing unit 41 returns a message “No match found” in step 730, and the routine again ends. If there is one or more criteria sets with a non-zero number of search results, processing unit 41 proceeds to step 735. In step 735, processing unit 41 determines how many criteria sets with the number of search results in the respective collections smaller than a second limit are there. In this instance, the second limit is set at four. This second limit represents the maximum number of search results in a collection over which processing unit 41 cannot confidently declare that the search results contain the desired latest contract information. If there are no such criteria sets, then processing unit 41 returns a message “No match found” in step 730, and the routine depicted in FIG. 7A ends. If there is only one such criteria set, processing unit 41 in step 7 returns the corresponding collection of search results and confidence measure, indicating the likelihood that the collection contains the desired, latest contact information, and the routine comes to an end.

If there are two or more such criteria sets, processing unit 41 proceeds to step 760 in FIG. 7B. In the instant example, criteria set 405 and criteria set 505 each produce fewer than four search results and, therefore, are further analyzed by processing unit 41. In step 760, processing unit 41 determines how many criteria sets with confidence measures greater than a third limit are there. In this instance, the third limit is set to 89. This third limit represents the minimum confidence measure for criteria sets left for consideration, which also produce a small number of search results (i.e., below the second limit), based on which processing unit 41 may confidently determine the collection of search results containing the desired latest contact information. The third limit may be set at a high confidence value. If there are no such criteria sets, processing unit 41 proceeds to step 715 in FIG. 7A described above. If there is only one criteria set with confidence measure above 89 (and concomitantly with fewer than four search results), processing unit 41 in step 775 returns the collection of search results corresponding to this criteria set most likely containing the desired latest contact information, and the routine comes to an end.

If there are two or more criteria sets each with fewer than four search results and a confidence measure above 89, processing unit 41 proceeds to step 805 in FIG. 7C. In step 805, processing unit 41 selects criteria sets with two highest confidence measures. In this example, processing unit 41 selects search results for criteria sets 505 and 605 because they have confidence measures of 94 and 90, respectively. In step 810, processing unit 41 determines if criteria set with the higher confidence measure, i.e., in this example criteria set 505, has fewer search results than the criteria set with the lower confidence measure, i.e., criteria set 605. Since criteria set 505 returned three search results and criteria set 605 returned one search result, the condition in step 810 is not satisfied and processing unit 41 proceeds to step 820. Otherwise, processing unit 41 would proceed to step 815 by returning the collection of search results corresponding to the criteria set with the higher confidence measure, and the routine then comes to an end. As a result, a collection of search results is selected which likely contains the desired latest contact information when the collection is associated with the highest confidence measure and includes the smallest number of search results.

However, in another scenario where there are at least two collections of search results left for further analysis, in which a first collection with a relatively high confidence measure and a relatively large number of search results, and a second collection with a relatively low confidence measure and relatively small number of search results. The process of selecting a single collection of search results as most likely containing the desired latest contact information takes into account not only a difference (a delta number) between the numbers of search results in the first and second collections, but also a fourth limit. This fourth limit relates to a measure of a difference of the respective confidence measures associated with the first and second collections. The second collection, assigned a lower confidence measure, may be selected as containing the desired latest contact information over the first collection, assigned a higher confidence measure, if certain conditions based on the difference between the numbers of search results in the first and second collections and the fourth limit are satisfied.

In this example, let's say the first collection produced using criteria set 505 contains three search results and is associated with a confidence measure of 94, and the second collection produced using criteria set 605 contains one search result and is associated with a confidence measure of 90. It should be noted that the respective respective numbers of search results in the first and second collections are very close to each other. Their confidence measures are also very close to each other. In accordance with the invention in step 820, processing unit 41 determines the difference between the numbers of search results corresponding to the respective criteria sets under consideration, i.e., delta number. In this example, the delta number equals two. In addition, the aforementioned fourth limit is determined as a function of the delta number. In this instance, the value of the fourth limit varies with the delta number. That is, the higher the delta number, the higher the fourth limit value is.

As fully disclosed hereinbelow, the difference (a delta confidence) between the confidence measures associated with the first and second collections is compared against the fourth limit. In this example, the delta number equals 2, the fourth limit may be set at five. In another example, where the delta number equals 1, the fourth limit would be set at a value lower than five, say, three. This lower value of the fourth limit is based on the observation that when delta number equals 1 vs. delta number equals 2, more accurate contact information would come from the collection of search results associated with a lower confidence measure provided that delta confidence is less than the fourth limit.

After determining the values of the delta number and the fourth limit, processing unit 41 proceeds to step 840. In step 840, processing unit 41 determines if the delta confidence is smaller than the fourth limit. Since this is true, processing unit 41 proceeds to step 830 and returns the collection of search results associated with the lower confidence measure, i.e., the collection corresponding to criteria set 605. Processing unit 41 returns the collection of search results produced by criteria set with the lower confidence measure because, at a level of confidence measures above the third limit, it prefers the lower number of search results which is likely to contain the desired latest contact information. Otherwise, processing unit 41 proceeds to step 835 and returns the collection of search results of criteria set with a higher confidence measure.

If in step 820, processing unit 41 determines that the delta number is one, then processing unit 41 in step 840 sets the fourth limit at, say, three, and determines if the delta confidence is smaller than the fourth limit. In another example, assume that the two collections of search results under consideration in step 840 are the first collection, i.e., collection produced by criteria set 905, with confidence measure of 95 and two search results (not shown), and the second collection, i.e., collection produced by criteria set 900 with confidence measure of 90 and one search result (not shown). Since the delta confidence is five, i.e., 95 (of criteria set 905) minus 90 (of criteria set 900), and is greater than the fourth limit of three, processing unit 41 proceeds to step 835 and returns search results of criteria set with a higher confidence measure, i.e., search results of criteria set 905. Otherwise, processing unit 41 executes step 830 and returns search results of a criteria set with the lower confidence measure. Then the routine comes to an end. If in step 820, processing unit 41 determines that the difference is three or more, processing unit 41 proceeds to step 730 in FIG. 7A as described above.

In another embodiment, confidence measures for criteria sets may be adjusted based on the actual data from an old recorded used. For example, if a criteria set includes a first name, and without knowledge of the particular first name searched for, it was assigned a confidence measure of 50, the confidence measure may be adjusted based on statistics of how many people prefer to list their nickname as their full name. For example, if the first name criterion is “William” the statistical data may indicate that 10 percent of Williams in the general population prefer to list themselves as “Bill”. In this instance, the confidence measures for every search which includes a “William” as a first name criterion may be adjusted upward by a positive bias, say, one to reflect a low likelihood that the William being searched may refer to himself as Bill. Hence, the criteria set previously assigned a confidence measure of would now be assigned a confidence measure of 51.

In another example, if the first name criterion is “Robert” the statistical data may indicate that 50 percent of Roberts in the general population prefer to list themselves as “Bob.”

In this instance, the confidence measures for every search which includes a “Robert” as a first name criterion may be adjusted upward by a positive bias, say, one to reflect a high likelihood that the Robert being searched may list himself as Bob. In general, if the statistical data indicates that 10-20 percent of the general population prefer to list themselves by their nickname rather than full first name, the confidence measures for the criteria sets including a first name criterion may be adjusted upward by one. If the statistical data indicates that 21-39 percent of the general population prefer to list themselves by their nickname rather than full first name, the confidence measures for the criteria sets including a first name criterion may stay the same. If the statistical data indicates that 40-80 percent of the general population prefer to list themselves by their nickname rather than full first name, the confidence measures for the criteria sets including a first name criterion may be adjusted downward by one.

Another example of adjusting the confidence measures based on the actual data in an old record is based on assessing the correctness of the address in an old record against the verified database of addresses, e.g., a United States Postal Service address database. For example, if a check of the address in old record 201 (1500 Robinson Drive, Mohawk, Nebr. 64553) against the USPS address database reveals that there is no Robinson Drive in the 64553 zip code assigned to Mohawk, Nebr., the confidence measures for criteria sets which include the street name and/or street type criteria would be adjusted downward by a negative bias, say, two to reflect a high likelihood that at least one data element in old record 201 is inaccurate. Otherwise, if the comparison of old record 201 with the USPS database demonstrates that every element of the address in old record 201 is verified, then the preassigned confidence measures remain the same.

In another embodiment, the confidence measures for criteria sets may be adjusted after executing a search using a particular criteria set involving the name of the searched party and the city in which the searched party resides. For example, a pre-assigned confidence measure of one such criteria set may be adjusted based on the size of that city's population and the number of search results produced by that criteria set. Assume that the population of Mohawk, Nebr. of old record 201 is 1,000 people, and a search using the criteria set produces twenty search results. Processing unit 41 calculates the ratio of the number of search results, i.e., twenty, to the size of Mohawk's population, i.e., 1,000. The ratio is 0.02. Based on the ratio of 0.02, the confidence measure for this criteria set may be adjusted downward by a negative bias, say, one to reflect that the name of the searched party is not that distinctive, when compared with the case where the same number of search results emerge if the city is Chicago, instead, having a population of ten million. In that case, the ratio of the number of search results, i.e., twenty, to the size of Chicago's population, i.e., 10,000,000, is 0.000002. Based on the ratio of 0.000002, the confidence measure for this criteria set may be adjusted upward by a positive bias, say one to reflect the more distinctiveness of the searched party's name.

It would be appreciated by those skilled in the art that, in a different embodiment, different relative values of confidence measures may be assigned to similar criteria sets which include criterion variations.

It would be appreciated by those skilled in the art that, in a different embodiment, one or more limits could be higher or lower than in the exemplary embodiment discussed above. For example, an entity requesting latest contact information for different individuals may not limit itself to just one, two, or three search results, but may set a higher number of search results, say twenty, as a meaningful number of leads for latest contact information. In this case, all other limits may be adjusted upward based upon empirical experience of a human operator.

It would be appreciated by those skilled in the art that, in a different embodiment, different criteria variations than removal or translation can be used to generate criteria sets. For example, a first name “William” can be truncated into “W*,” where the star-character would match a textual string of any length. Hence, criterion variation “W*” would match “W,” “Will,” “Willard,” “Wonka,” etc.

The foregoing merely illustrates the principles of the invention. It will thus be appreciated that those skilled in the art will be able to devise numerous other arrangements which embody the principles of the invention and are thus within its spirit and scope.

Finally, processing unit 41 and database storage 20 are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing at least one selected search result responsive to a search of at least one database for desired contact information concerning an entity based on a given contact information record concerning the entity, the method comprising:
conducting a first search of the database for the desired contact information using a first criteria set derived from the given contact information record, the first criteria set being associated with a first confidence measure;
conducting a second search of the database for the desired contact information using a second criteria set derived from the given contact information record, the second criteria set being associated with a second confidence measure;
obtaining a first set of one or more search results responsive to the first search, the first confidence measure indicating a first likelihood that the first set of search results contains the desired contact information;
obtaining a second set of one or more search results responsive to the second search, the second confidence measure indicating a second likelihood that the second set of search results contains the desired contact information;
selecting the first set of search results over the second set of search results based on at least relative values of the first and second confidence measures and a number of search results in the first set; and
providing the selected, first set of search results.

2. The method of claim 1 wherein the first set of search results is selected over the second set of the search results when the first confidence measure is greater than the second confidence measure and a number of search results in the first set is smaller than a predetermined number.

3. The method of claim 1 wherein the first set of search results is selected over the second set of the search results when the first confidence measure is greater than or equal to a predetermined value, and the second confidence measure is less than the predetermined value, and a number of search results in the first set is smaller than a predetermined number.

4. The method of claim 1 wherein the first set of search results is selected over the second set of the search results when the first confidence measure and the second confidence measure are greater than a predetermined value, and a first number of search results in the first set is smaller than a predetermined number, and the first number is smaller than a second number of search results in the second set of search results.

5. The method of claim 1 wherein the second set of search results is selected over the first set of the search results when (a) the first confidence measure and the second confidence measure are greater than a first predetermined value, (b) a first number of search results in the first set is greater than a second number of search results in the second set of search results, (c) the first number and the second number are smaller than a first predetermined number, and (d) a difference between the first confidence measure and the second confidence measure is less than a second predetermined value which is a function of a difference between the first number and the second number.

6. The method of claim 1 wherein the given contact information record includes a plurality of contact information elements.

7. The method of claim 6 wherein the first criteria set is derived from the given contact information record by removing at least one of the contact information elements.

8. The method of claim 6 wherein the first criteria set is derived from the given contact information record by including an equivalent of the at least one of the contact information elements.

9. The method of claim 6 wherein at least one of the contact information elements comprises a string of characters, the first criteria set being derived from the given contact information record by including a subset of the characters in the string.

10. The method of claim 6 wherein at least one of the contact information elements comprises a first string of characters, the first criteria set being derived from the given contact information record by including at least a second string of characters relating to the first string.

11. The method of claim 8 wherein the at least one contact information elements includes a first name element, and at least one equivalent thereof, which includes a selected one of a nickname, short name, alias, and pseudonym.

12. The method of claim 8 wherein the at least one contact information elements includes a street type element, and at least one equivalent thereof, which includes a selected one of an avenue, boulevard, parkway, road, circle, way, route, street, square, and drive.

13. The method of claim 6 wherein the at least one of the contact information elements includes a selected one of a first name, last name, middle name, house number, street prefix, street name, street type, apartment number, city, state, postal code, telephone area code, and phone number.

14. The method of claim 8 wherein the at least one contact information element includes a first name element, and the first confidence measure is adjusted as a function of a frequency of use of an equivalent of the first name element.

15. The method of claim 8 wherein the at least one contact information elements includes a city element, and the first confidence measure is adjusted as a function of at least a size of a population of a city defined by the city element.

16. The method of claim 15 wherein the first confidence measure is adjusted also as a function of a number of search results in the first set.

17. The method of claim 16 wherein the first confidence measure is adjusted as a function of a ratio of the number of search results in the first set to the size of a population of the city.

18. The method of claim 1 wherein the first confidence measure is adjusted based on a result of checking an address in the given contact information against a second database.

19. A system for providing at least one selected search result responsive to a search of at least one database for desired contact information concerning an entity based on a given contact information record concerning the entity, the method comprising:
a first processor for conducting a first search of the database for the desired contact information using a first criteria set derived from the given contact information record, the first criteria set being associated with a first confidence measure;
a second processor for conducting a second search of the database for the desired contact information using a second criteria set derived from the given contact information record, the second criteria set being associated with a second confidence measure;
the first processor for obtaining a first set of one or more search results responsive to the first search, the first confidence measure indicating a first likelihood that the first set of search results contains the desired contact information;
the second processor for obtaining a second set of one or more search results responsive to the second search, the second confidence measure indicating a second likelihood that the second set of search results contains the desired contact information;
the first processor for selecting the first set of search results over the second set of search results based on at least relative values of the first and second confidence measures and a number of search results in the first set; and
an interface for providing the selected, first set of search results.

20. The system of claim 19 wherein the first set of search results is selected over the second set of the search results when the first confidence measure is greater than the second confidence measure and a number of search results in the first set is smaller than a predetermined number.

21. The system of claim 19 wherein the first set of search results is selected over the second set of the search results when the first confidence measure is greater than or equal to a predetermined value, and the second confidence measure is less than the predetermined value, and a number of search results in the first set is smaller than a predetermined number.

22. The system of claim 19 wherein the first set of search results is selected over the second set of the search results when the first confidence measure and the second confidence measure are greater than a predetermined value, and a first number of search results in the first set is smaller than a predetermined number, and the first number is smaller than a second number of search results in the second set of search results.

23. The system of claim 19 wherein the second set of search results is selected over the first set of the search results when (a) the first confidence measure and the second confidence measure are greater than a first predetermined value, (b) a first number of search results in the first set is greater than a second number of search results in the second set of search results, (c) the first number and the second number are smaller than a first predetermined number, and (d) a difference between the first confidence measure and the second confidence measure is less than a second predetermined value which is a function of a difference between the first number and the second number.

24. The system of claim 19 wherein the given contact information record includes a plurality of contact information elements.

25. The system of claim 24 wherein the first criteria set is derived from the given contact information record by removing at least one of the contact information elements.

26. The system of claim 24 wherein the first criteria set is derived from the given contact information record by including an equivalent of the at least one of the contact information elements.

27. The system of claim 24 wherein at least one of the contact information elements comprises a string of characters, the first criteria set being derived from the given contact information record by including a subset of the characters in the string.

28. The system of claim 24 wherein at least one of the contact information elements comprises a first string of characters, the first criteria set being derived from the given contact information record by including at least a second string of characters relating to the first string.

29. The system of claim 26 wherein the at least one contact information elements includes a first name element, and at least one equivalent thereof, which includes a selected one of a nickname, short name, alias, and pseudonym.

30. The system of claim 26 wherein the at least one contact information elements includes a street type element, and at least one equivalent thereof, which includes a selected one of an avenue, boulevard, parkway, road, circle, way, route, street, square, and drive.

31. The system of claim 24 wherein the at least one of the contact information elements includes a selected one of a first name, last name, middle name, house number, street prefix, street name, street type, apartment number, city, state, postal code, telephone area code, and phone number.

32. The system of claim 19 wherein the first processor includes the second processor.

33. The system of claim 26 wherein the at least one contact information element includes a first name element, and the first confidence measure is adjusted as a function of a frequency of use of an equivalent of the first name element.

34. The system of claim 26 wherein the at least one contact information elements includes a city element, and the first confidence measure is adjusted as a function of at least a size of a population of a city defined by the city element.

35. The system of claim 34 wherein the first confidence measure is adjusted also as a function of a number of search results in the first set.

36. The system of claim 35 wherein the first confidence measure is adjusted as a function of a ratio of the number of search results in the first set to the size of a population of the city.

37. The system of claim 19 wherein the first confidence measure is adjusted based on a result of checking an address in the given contact information against a second database.
